(19) United States
(12) Patent Application Publication
(10) Pub. No.: US 2013/0053012 A1
(43) Pub. Date: Feb. 28, 2013

(54) METHODS AND SYSTEMS FOR DETERMINING A LOCATION BASED PREFERENCE METRIC FOR A REQUESTED PARAMETER

(71) Applicant: Chinmay S. DHODAPKAR, San Diego, CA (US)

(72) Inventor: Chinmay S. DHODAPKAR, San Diego, CA (US)

(21) Appl. No.: 13/215,945

(22) Filed: Aug. 23, 2011

(51) Int. Cl. H04W 4/02; H04W 24/00

(52) U.S. Cl. 455/418; 455/456.1

(57) ABSTRACT

Methods and apparatus for determining preference data may include determining a location based preference metric for a requested ambient parameter according to a measure of preference for the ambient parameter corresponding to one or more wireless devices within a location during a time period. The methods and apparatus may further include environmental control of one or more ambient controls in a location based upon the received location based preference metric.

### BACKGROUND

The described aspects relate to controlling a parameter in a location, and more particularly, to methods and systems for determining a location based preference metric for a given parameter.

Department stores, for example, usually play music while customers are shopping so as to make the customers experience in the department store more enjoyable and increase the amount of time customers spend in a department store thus increasing the amount of money customers spend while shopping. Since a wide demographic of customers typically shop in a department stores, the stores and other public locations play genres of music, such as jazz, which will not offend most people while shopping in the department store. However, by playing genres of music which will not offend most people, however, the department stores may not be appealing to the customers shopping in the department store.

Thus, it would be beneficial to have a system that could customize the music playing and/or other features or parameters in an area based upon a preference of individuals currently within the area.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

One aspect relates to a method for providing preference data associated with a wireless device. The method may include detecting, via a hardware component configured to operate with any of a plurality of software components, raw data generated by one of the plurality of software components prior to output of the raw data by an output mechanism. The raw data corresponds to one or more preferences. The method may also include sampling the detected raw data in a time increment. In addition, the method may include transmitting the sampled data corresponding to one or more preferences. The sampled data affects a control of one or more ambient parameters in a location of the wireless device.

Another aspect relates to at least one processor configured to provide preference data associated with a wireless device. The process may include a first module for detecting, via a hardware component configured to operate with any of a plurality of software components, raw data generated by one of the plurality of software components prior to output of the raw data by an output mechanism. The raw data corresponds to one or more preferences. The processor may additionally include a second module for sampling the detected raw data in a time increment. The processor may further include a third module for transmitting the sampled data corresponding to one or more preferences. The sampled data affects a control of one or more ambient parameters in a location of the wireless device.

Yet another aspect relates to a computer program product. The computer program product may include a computer-readable medium including at least one instruction for causing a computer to detect, via a hardware component configured to operate with any of a plurality of software components, raw data generated by one of the plurality of software components prior to output of the raw data by an output mechanism. The raw data corresponds to one or more preferences. The computer readable medium may also include at least one instruction for causing the computer to sample the detected raw data in a time increment. In addition, the computer-readable medium may include at least one instruction for causing the computer to transmit the sampled data corresponding to one or more preferences. The sampled data affects a control of one or more ambient parameters in a location of the wireless device.

Another aspect relates to an apparatus for providing preference data associated with a wireless device. The apparatus may include means for detecting, via a hardware component configured to operate with any of a plurality of software components, raw data generated by one of the plurality of software components prior to output of the raw data by an output mechanism. The raw data corresponds to one or more preferences. Moreover, the apparatus may include means for sampling the detected raw data in a time increment. The apparatus may further include means for transmitting the sampled data corresponding to one or more preferences. The sampled data affects a control of one or more ambient parameters in a location of the wireless device.

Another aspect relates to a wireless device for communicating data. The wireless device may include a detector operable to detect raw data generated by one of the plurality of software components prior to output of the raw data by an output mechanism. The raw data corresponds to one or more preferences. The wireless device may additionally include a sampler operable to sample the detected raw data in a time increment. The wireless device may also include a transmitter operable to transmit the sampled data corresponding to one or more preferences. The sampled data affects a control of one or more ambient parameters in a location of the wireless device.

Yet another aspect relates to a method for determining preferences. The method may include receiving a request for a preference relating to an ambient parameter corresponding to a location. The method may also include determining a location based preference metric for the requested ambient parameter according to a measure of preference for the ambient parameter corresponding to one or more wireless devices within the location during a time period. At least a portion of the measure of preference for each of the one or more wireless devices is based on preference data corresponding to sampled raw data generated by one of a plurality of software components on each wireless device prior to output of the sampled raw data by an output mechanism on each wireless device. In addition, the method may include transmitting the location based preference metric.

Another aspect relates to at least one processor configured to determine preferences. The processor may include a first module for receiving a request for a preference relating to an ambient parameter corresponding to a location. The processor may further include a second module for determining a location based preference metric for the requested ambient parameter according to a measure of preference for the ambient parameter corresponding to one or more wireless devices within the location during a time period. The at least a portion of the measure of preference for each of the one or more wireless devices is based on preference data corresponding to sampled raw data generated by one of a plurality of software components on each wireless device prior to output of the sampled raw data by an output mechanism on each wireless device. Moreover, the processor may include a third module for transmitting the location based preference metric.

Another aspect relates to a computer program product. The computer program product may include a computer-readable medium including at least one instruction for causing a computer to receive a request for a preference relating to an ambient parameter corresponding to a location. The computer-readable medium may also include at least one instruction for causing the computer to determine a location based preference metric for the requested ambient parameter according to a measure of preference for the ambient parameter corresponding to one or more wireless devices within the location during a time period. The at least a portion of the measure of preference for each of the one or more wireless devices is based on preference data corresponding to sampled raw data generated by one of a plurality of software components on each wireless device prior to output of the sampled raw data by an output mechanism on each wireless device. The computer-readable medium may additionally include at least one instruction for causing the computer to transmit the location based preference metric.

Yet another aspect relates to an apparatus. The apparatus may include means for receiving a request for a preference relating to an ambient parameter corresponding to a location. The apparatus may further include means for determining a location based preference metric for the requested ambient parameter according to a measure of preference for the ambient parameter corresponding to one or more wireless devices within the location during a time period. The at least a portion of the measure of preference for each of the one or more wireless devices is based on preference data corresponding to sampled raw data generated by one of a plurality of software components on each wireless device prior to output of the sampled raw data by an output mechanism on each wireless device. In addition, the apparatus may include means for transmitting the location based preference metric.

Another aspect relates to a server for transmitting a location based preference metric for a requested parameter and location. The server may include a location based preference determiner operable to receive a request for a preference relating to an ambient parameter corresponding to a location, and determine a location based preference metric for the requested ambient parameter according to a measure of preference for the ambient parameter corresponding to one or more wireless devices within the location during a time period. The at least a portion of the measure of preference for each of the one or more wireless devices is based on preference data corresponding to sampled raw data generated by one of a plurality of software components on each wireless device prior to output of the sampled raw data by an output mechanism on each wireless device. The location based preference determiner is further operable to transmit the location based preference metric.

Yet another aspect relates to a method of environmental control. The method may include sending a request for a preference relating to an ambient parameter corresponding to a location. The method may also include receiving a location based preference metric for one or more wireless devices within the location. The location based preference metric for the requested ambient parameter is based on a measure of preference for the ambient parameter corresponding to one or more wireless devices within the location during a time period. The at least a portion of the measure of preference for each of the one or more wireless devices is based on preference data corresponding to sampled raw data generated by one of a plurality of software components on each wireless device prior to output of the sampled raw data by an output mechanism on each wireless device. In addition, the method may include changing one or more ambient controls in the location based upon the received location based preference metric.

Another aspect relates to at least one processor configured for environmental control. The processor may include a first module for sending a request for a preference relating to an ambient parameter corresponding to a location. The processor may further include a second module for receiving a location based preference metric for one or more wireless devices within the location. The location based preference metric for the requested ambient parameter is based on a measure of preference for the ambient parameter corresponding to one or more wireless devices within the location during a time period. The at least a portion of the measure of preference for each of the one or more wireless devices is based on preference data corresponding to sampled raw data generated by one of a plurality of software components on each wireless device prior to output of the sampled raw data by an output mechanism on each wireless device. The processor may additionally include a third module for changing one or more ambient controls in the location based upon the received location based preference metric.

Another aspect relates to a computer program product. The computer program product may include a computer-readable medium including at least one instruction for causing a computer to send a request for a preference relating to an ambient parameter corresponding to a location. The computer-readable medium may further include at least one instruction for causing the computer to receive a location based preference metric for one or more wireless devices within the location. The location based preference metric for the requested ambient parameter is based on a measure of preference for the ambient parameter corresponding to one or more wireless devices within the location during a time period. At least a portion of the measure of preference for each of the one or more wireless devices is based on preference data corresponding to sampled raw data generated by one of a plurality of software components on each wireless device prior to output of the sampled raw data by an output mechanism on each wireless device. In addition, the computer readable-medium may include at least one instruction for causing the computer to change one or more ambient controls in the location based upon the received location based preference metric.

Another aspect relates to an apparatus. The apparatus may include means for sending a request for a preference relating to an ambient parameter corresponding to a location. The apparatus may also include means for receiving a location based preference metric for one or more wireless devices within the location. The location based preference metric for the requested ambient parameter is based on a measure of preference for the ambient parameter corresponding to one or more wireless devices within the location during a time period. The at least a portion of the measure of preference for each of the one or more wireless devices is based on preference data corresponding to sampled raw data generated by one of a plurality of software components on each wireless device prior to output of the sampled raw data by an output mechanism on each wireless device. Moreover, the apparatus may include means for changing one or more ambient controls in the location based upon the received location based preference metric.

Yet another aspect relates to an apparatus for environmental control. The apparatus may include a requestor component operable to send a request for a preference relating to an ambient parameter corresponding to a location. The apparatus may further include a controller operable to receive a location based preference metric for one or more wireless devices within the location. The location based preference metric for the requested ambient parameter is based on a measure of preference for the ambient parameter corresponding to one or more wireless devices within the location during a time period. At least a portion of the measure of preference for each of the one or more wireless devices is based on preference data corresponding to sampled raw data generated by one of a plurality of software components on each wireless device prior to output of the sampled raw data by an output mechanism on each wireless device. In addition, the apparatus may include an ambient control component operable to change one or more ambient controls in the location based upon the received location based preference metric.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is an illustration of a connectivity system in accordance with an aspect;

FIG. 2 is an illustration of an example sample generator in accordance with another aspect;

FIG. 3 is an illustration of an example tracker component in accordance with yet another aspect;

FIG. 4 is an illustration of an example location based preference determiner in accordance with still another aspect;

FIG. 5 is a flow chart illustrating a method for providing preference data associated with a wireless device in accordance with another aspect;

FIG. 6 is a flow chart illustrating a method for populating a data repository with individual user preferences in accordance with still another aspect;

FIG. 7 is a flow chart illustrating a method for determining preferences in accordance with yet another aspect;

FIG. 8 is a flow chart illustrating a method for environmental control in accordance with another aspect;

FIG. 9 an example wireless device operable within the connectivity system in accordance with an aspect;

FIG. 10 is an example server device operable within the connectivity system in accordance with yet another aspect;

FIG. 11 is an illustration of an example system that facilitates providing preference data associated with a wireless device in accordance with another aspect;

FIG. 12 is an illustration of an example system that facilitates determining preferences in accordance with another aspect; and

FIG. 13 is an illustration of an example system that facilitates environmental control in accordance with still another aspect.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described aspects relate to methods and systems for providing preference data associated with one or more wireless devices in a location. The preference data may be used to generate a location based preference metric calculated based on a measure of preference of one or more wireless devices within the location. The described aspects also relate to methods and systems for environment control in a location based upon the received preference data associated with the one or more wireless devices within the location.

In addition, in an aspect, the described aspects relate to methods and systems for detecting raw data on a wireless device, sampling the detected raw data and transmitting the sampled data where the sampled data affects a control of one or more ambient parameters in a location of the wireless device. The sampled data may correspond to one or more preferences of one or more wireless devices.

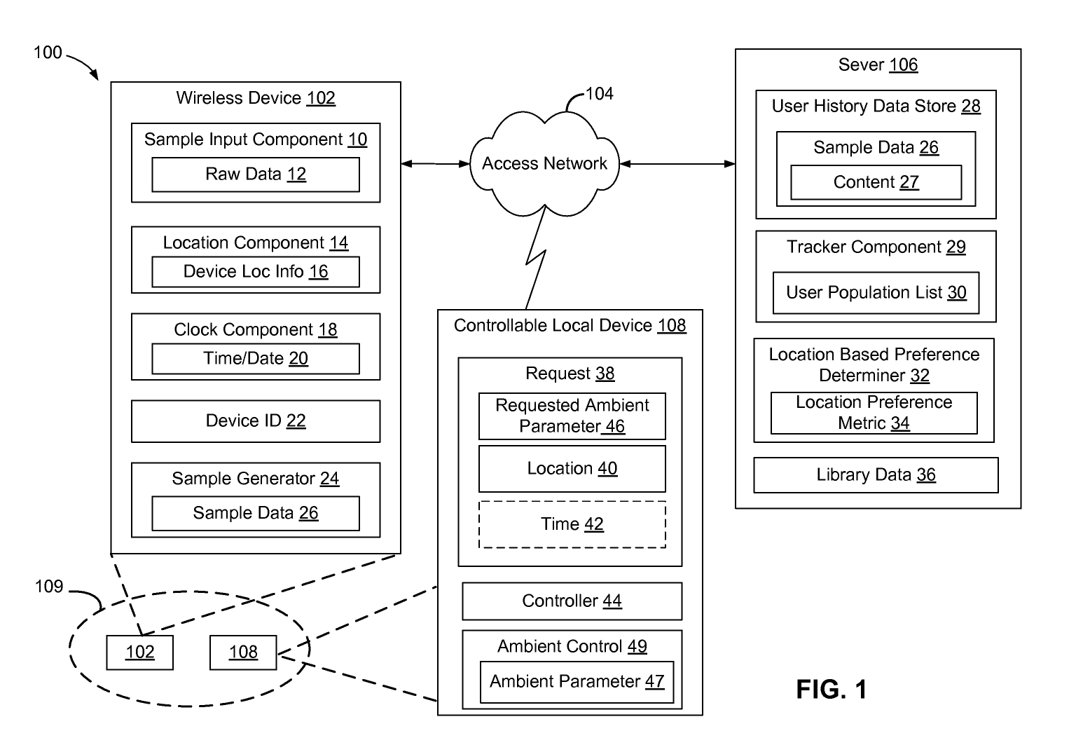

Referring now to FIG. 1, illustrated is an example connectivity system 100 that includes one or more wireless devices 102 communicating through one or more access networks 104 with one or more servers and/or computing devices 106 in order to provide preference information of each wireless device 102 to affect an ambient parameter 47 generated by a controllable local device 108 in a location 109 where each wireless device 102 is positioned, according to one aspect. Wireless device 102 may include any mobile, portable computing or communications device, such as a cellular device, that may connect to an access network 104. Wireless device 102 may be, for example, a cellular telephone, a navigation system, a computing device, a camera, a PDA, a music device, a gaming device, or a handheld device having wireless connection capability, among other devices. Server/computing device 106 and controllable local device 108 may include any mobile or fixed computing device connected to a network. For example, controllable local device 108 may include, but is not limited to, a music player device, a video player device, a gaming device, a lighting device, a heating device, a cooling device, among other devices.

In addition, access network 104 may provide one or more types of communication connections, such as any type of wireless airlink, to wireless device 102, controllable local device 108, and server 106. Wireless device 102 may place and/or receive a communication, e.g., a telephone call, a conference call, a video conferencing call, an Internet Protocol session, a Voice Over Internet protocol (IP) call, a short message service (SMS) message, a multimedia messaging service (MMS) message, an instant messaging (IM) service message, a chat or net-meeting related connection, a video, music, or data transfer, among other communications, via access network 104 to and/or from one or more servers 106. In addition, wireless device 102 may receive a communication via access network 104 from one or more servers 106, or from any other device in communication with access network 104.

Wireless device 102 may include a sample input component 10 operable to generate or otherwise obtain raw data 12 corresponding to operation of the wireless device, and a sample generator component 24 that may obtain at least a portion of raw data 12 as sample data 26 and transmit sample data 26 to server 106. For example, in an aspect relating to a music or video file being played by wireless device 102, or audio signals being received by a microphone of wireless device 102, sample input component 10 may generate or receive raw data 12 corresponding thereto. In an aspect, sample input component 10 may include, but is not limited to, a speaker, a microphone, a thermometer, a light meter, an external environment sensor, a keyboard, a display, an application executing on the device, a memory, a processor, among other input-generating components of wireless device 102. Raw data 12 may include, but is not limited to, device state parameters, device external environment parameters, and device generated output parameters. Device generated output parameters may include, for example, music, sound, non-voice audio, video, and volume of the music, among other device generated output parameters. Device external environment parameters may include parameters sensed adjacent to the wireless device, such as temperature, lighting, color, music, and non-voice audio, among other external environmental parameters. Device state parameters may include, but not limited to, for example, one or more device settings.

Wireless device 102 may also include a location component 14 operable for determining device location information 16. Location component 14 may be a position/location component (e.g. a Global Positioning System (GPS) module, or a terrestrial or cellular network based location module, etc.) on the wireless device, indicating the geographic coordinates where the data content was captured, or a network identifier corresponding to a network component having a location that can be identified. In addition, wireless device 102 may include a clock component 18 operable for generating the current date and/or time 20. Location component 14 and clock component 18 may interface with sample input component 10 or sample generator 24 to generate device location information 16 and/or the time and date 20 when the raw data 12 was detected or when the sample data 26 was collected. Wireless device 102 may also include a device identifier (ID) 22 operable for generating a unique identification for the wireless device 102, which also may be associated with the collected data.

As noted, sample generator component 24 is operable for detecting the raw data 12, sampling the detected raw data 12 and transmitting the sampled data 26 to server 106 for additional processing and/or storing. Sample generator 24 may interface with the sample input component 10, the location component 14, and the clock component 18, for example, to provide server 106 with the sampled data 26 and the corresponding time/date 20 and/or device location information 16 corresponding to the sampled data 26, which may be utilized by server 106 in making a preference determination. The sampled data 26 may relate to one or more preferences corresponding to one or more wireless devices 102 within the location.

Server 106 may receive the sampled data 26 and generate a location based preference metric 34 for controlling an ambient parameter 47 of a controllable local device 108 in a location 109. Location based preference metric 34 may be based on a measure of preference for each of the one or more wireless devices 102 within the location and the wireless devices' preference data, which may be based at least in part on the sampled data 26.

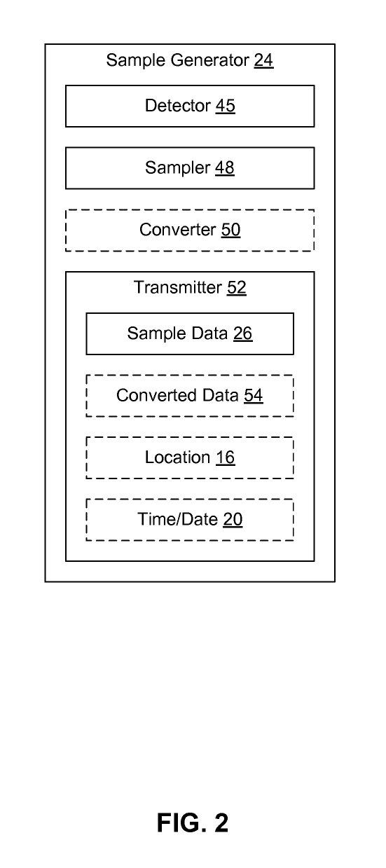

Referring now to FIG. 2, an example sample generator in accordance with an aspect is illustrated. In one aspect, sample generator 24 may include a detector component 45 operable to detect when raw data 12 is being played and/or listened to by wireless device 102. For example, a chipset on the wireless device may detect a raw audio or video file having audio data being played by the digital signal processor (DSP) and/or speaker of the wireless device. In another example, detector component 45 may detect a temperature of the surrounding area being detected by the thermometer of the wireless device. In yet another example, detector component 45 may detect a lighting level of the surrounding being detected by the light meter of the wireless device.

Sample generator 24 may also include a sampler component 48 operable to gather information corresponding to the detected raw data 12 and generate sampled data 26. In an aspect, sample generator 24 may include a chipset configured to take random samples of the detected raw data 12 in increments, such as one or more time periods, and generate sample data 26 based upon the samples taken. For example, the chipset may exchange a message with the application playing the data and take a five to ten seconds sample of the detected raw data while the data is playing. Sample generator 24 may optionally include a converter component 50 operable to convert the sampled data into another format. For example, the sample generator 24 in the form of the chipset may convert audio data into a graphical data, such as a spectrograph or other graphical representation of a sound spectrum of the audio data.

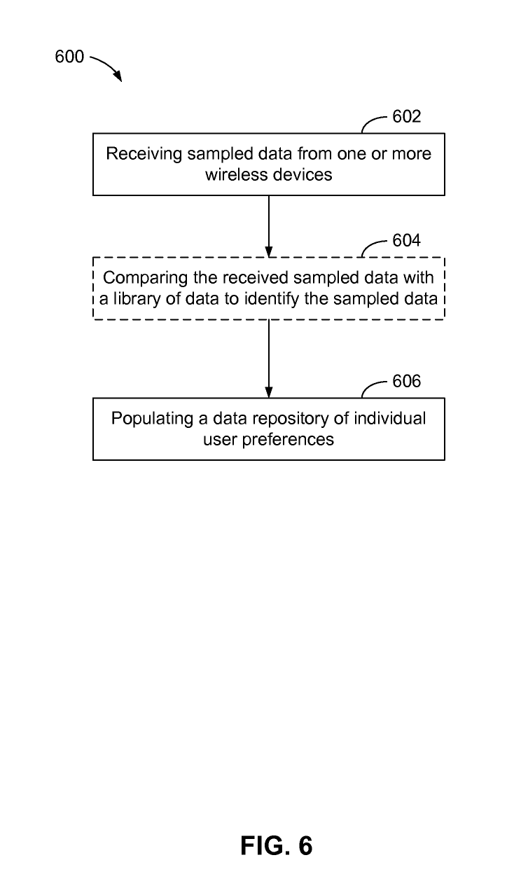

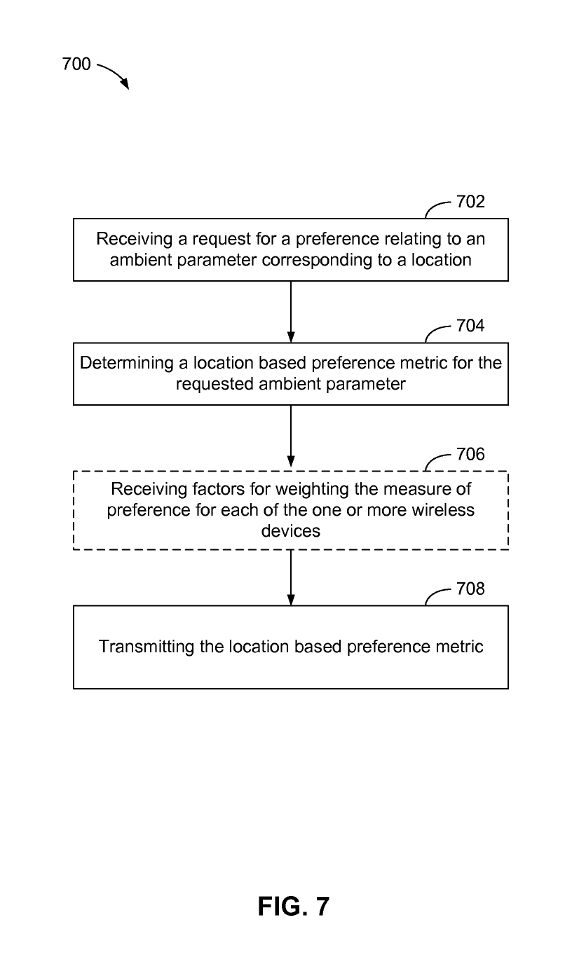

In addition, sample generator 24 may include or may communicate with a transmitting component 52 operable to transmit the sampled data 26 and the corresponding device identification (ID) 22. In an aspect, transmitter 52 may transmit the sampled data 26 to server 106 (FIG. 1), for example, for storage and/or additional processing, as discussed below in FIGS. 6-7. In another aspect, transmitter 52 may transmit the sampled data 26 in the form of converted data 54 to server 106 for storage and/or additional processing. Transmitter 52 and/or sample generator 24 may also obtain and transmit the device location information 16 and the time and/or date 20 corresponding to the sampled data 26 or converted data 54, for example, transmitting along with the sampled data 26 or converted data 54 or transmitted with some reference to the sampled data 26 or converted data 54.

Referring back to FIG. 1, server 106 may receive, for example, the transmitted sample data 26 associated with a device ID 22, the device location information 16 and the time and/or date 20 the sampled data 26 was obtained by wireless device 102 and store the transmitted information in a user history data store 28. In addition, server 106 may compare the received sample data 26 with a library of data 36 to identify content 27 defined by the sampled data 26. For example, server 106 may receive sample data 26 relating to a song playing on wireless device 102 and may compare the sampled data 26 with other song data from a library of songs to identify the song playing on wireless device 102.

Server 106 may also receive a communication via access network 104 from one or more controllable local devices 108 requesting, for example, a preference for an ambient parameter of one or more users corresponding to one or more wireless devices positioned within a location. In an aspect, controllable local device 108 may send a request 38 to server 106 with a requested ambient parameter 46 for which controllable local device 108 may want to receive a preference within location 40. In addition, request 38 may also include a time period 42 during which controllable local device 108 may want to receive a preference for the requested ambient parameter 46. Time period 42 may be, for example, an hour, a day, a week, or a month, among other time periods. Requested ambient parameter 46 may include, but is not limited to ambient parameters, such as music, sound, non-voice audio, video, volume, temperature, and lighting, among other parameters. Location 40 may include geographic areas, such as stores, shopping malls, sports arenas, airports, buildings, restaurants, book stores, and parks, among other geographic areas.

Server 106 may include a tracker component 29 operable to determine a user population list 30 of the one or more wireless devices 102 within one or more specified areas corresponding to the location. In addition, server 106 may include a location based preference determiner 32 which may receive request 38 from controllable local device 108 and generate, according to a preference function 63, a location preference metric 34 for the requested ambient parameter 46 based upon a preference of a user population list 30 within the specified location.

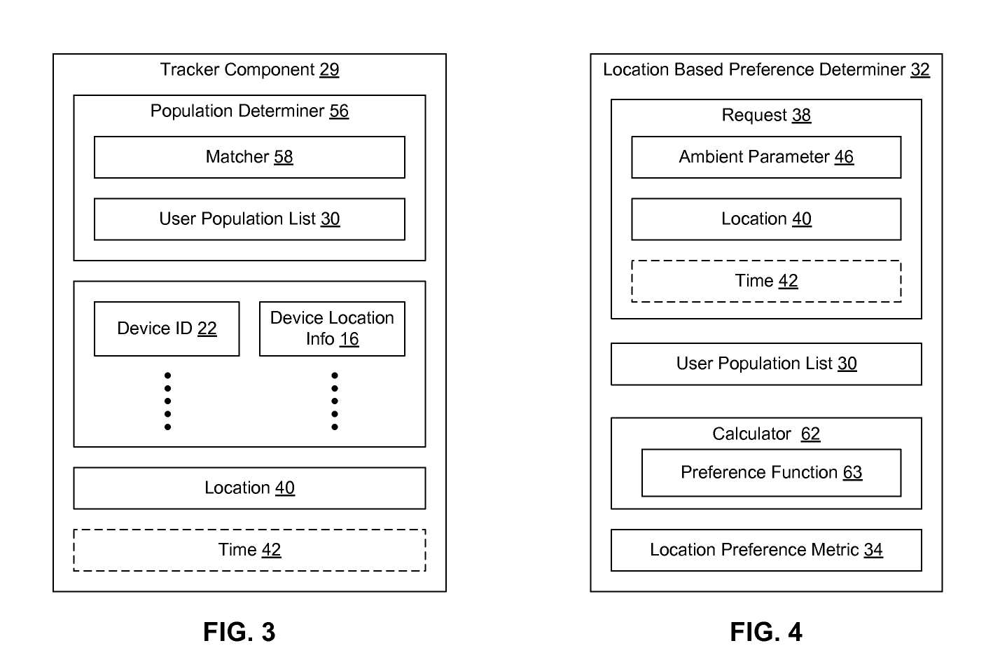

Referring now to FIG. 3, illustrated is an example tracker component in accordance with an aspect. Tracker component 29 may receive a location 40 and/or a time period 42 for determining a user population list 30. In addition, tracker component 29 may receive a list of device IDs 22 and device location information 16 for one or more wireless devices.

Tracker component 29 may also include a population determiner 56 operable to determine a user population list 30 of wireless devices within the specified location 40 during a specified time period 42. Population determiner 56 may include a matcher 58 that matches the received device ID 22 and device location information 16 with the specified location 40. If the received device location information 16 matches the specified location 40, the population determiner 56 may add the corresponding device IDs 22 to the user population list 30. In another aspect, matcher 58 may compare the received time and/or date information 20 with the specified time period 42 to determine whether the device location information 16 matches the specified time period 42. If a wireless device leaves the specified location 40, the population determiner 56 may remove the corresponding device ID 22 from the user population list 30. Thus, the population determiner 56 may generate a user population list 30 of wireless devices currently within the specified location 40.

Referring now to FIG. 4, illustrated is a location based preference determiner component 32 in accordance with an aspect. As discussed above, location based preference determiner 32 may receive a request 38 from controllable local device 108 with a requested ambient parameter 46 for which controllable local device 108 may want to receive a preference of individuals within location 40. Location based preference determiner 32 may identify the sampled data 26 that corresponds to the requested ambient parameter 46. In addition, request 38 may optionally include a time period 42 during which controllable local device 108 may want to receive the preference for requested ambient parameter 46. Location based preference determiner 32 may interface with tracker component 29 (FIGS. 1 and 3) to determine a user population list 30 which may identify one or more wireless devices 102 within location 40. For example, location based preference determiner 32 may access the sampled data 26 for the one or more wireless devices 102 in the user population list 30 and apply a matching function to the sampled data 26 to correlate the sampled data 26 with the requested ambient parameter 46 and determine which sampled data 26 corresponds to the requested ambient parameter 46.

Location based preference determiner 32 may also include calculator component 62. Calculator component 62 may interface with the user population list 30 and calculate a location based preference metric 34 according to a preference function 63 for the requested ambient parameter 46. For example, preference function 63 may include, but is not limited to, an algorithm, rule, fuzzy logic, or any other mechanism for calculating location based preference metric 34 for a location based on sampled data 26 corresponding to one or more wireless devices 102 in the location. Location based preference metric 34 may include, but is not limited to, a measure of a preference for the requested ambient parameter 46. Requested ambient parameter 46, and hence location based preference metric 34, may relate to controllable ambient variables, such as a type and/or volume of music being played, a temperature of a heating or air conditioning unit, a level of lighting, a color displayed on a wall, etc. For example, calculator component 62 may calculate a music preference, e.g. based on an average or some other mathematical function of user music preferences, for the user population list 30. In addition, calculator component 62 may calculate a measure of preference based on a combination of ambient parameters. For example, the measure of preference may be based upon a correlation between a genre of music being played by a wireless device and the level of lighting surrounding the wireless device.

In an aspect, calculator component 62 may interface with user history data store 28 and use the sample data 26 stored in the user history data store 28 when calculating the location based preference metric 34. In another aspect, calculator component 62 may receive the sample data 26 directly from the wireless devices on the user population list 30 and calculate the location based preference metric 34 based upon the data currently being played by the user population list 30.

Referring back to FIG. 1, controllable local device 108 may include a controller 44 that may control and/or change one or more ambient controls 49 to affect one or more ambient parameters 47 in the environment of location 40. Ambient controls may include, but are not limited to, a sound system, a lighting system, a display system, a video system, and a temperature system, among other ambient controls which may affect a number of individuals. Controller 44 may receive a location based preference metric 34 from server 106 for the requested ambient parameter 46 and may use the received location based preference metric 34 to change one or more ambient controls in location 40. For example, controllable local device 108 may want to receive an average preference of music of one or more wireless devices 102 currently within a particular store so that controllable local device 108 may adjust the genre of music playing in the store based upon the average music preference of the customers currently within the store. Controllable local device 108 may, for example, want to receive an average temperature preference of one or more wireless devices 102 currently within a particular store so that controllable local device 108 may adjust the temperature level in the store based upon a measure of preference of the wireless devices currently within the store.

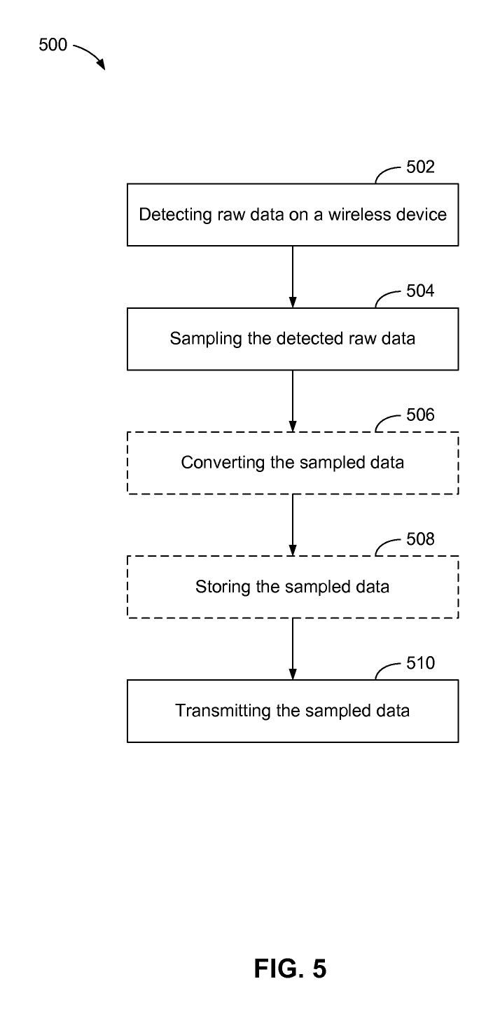

Referring now to FIG. 5, a method 500 for providing preference data in accordance with an aspect includes, at 502, detecting raw data on a wireless device. Raw data may include, but is not limited to, device environment parameters, device external environment parameters, and device generated output parameters. Device generated output parameters may include, for example, music, sound, non-voice audio, video, and volume of the music, among other device generated output parameters. Device external environment parameters may include parameters sensed adjacent to the wireless device, such as temperature, lighting, music, and non-voice audio, among other external environmental parameters. Device environment parameters may include device setting, for example. In an aspect, the raw data may correspond to one or more preferences associated with a wireless device.

Detecting raw data may include, but is not limited to, detecting, via a hardware component configured to operate with any of a plurality of software components (e.g., a chipset in the wireless device), raw data generated by one of the plurality of software components prior to output of the raw data by an output mechanism. For example, the chipset may detect a raw audio file being played by the digital signal processor (DSP) and/or speaker of the wireless device. It should be appreciated that the chipset may also detect music playing in the surrounding area, such as the user's home, work, and other locations where the user of the wireless device has spent a period of time. By detecting the raw data via the chipset, the system may be independent of various software and operating systems running on wireless devices, and therefore, has the flexibility of being used with multiple wireless devices irrespective of the operating system running on the wireless device. In addition, the chipset may automatically detect the raw data without interactions from the user.

At 504, the method may include sampling the detected raw data. Sampling the detected raw data may include, but is not limited to, gathering information corresponding to the data being played. In an aspect, the chipset may take random samples in time increments of the detected raw data to sample. For example, the chipset may exchange a message with the application playing the data and take a five to ten seconds sample of the detected raw data while the data is playing.

The method may optionally include, at 506, converting the sampled data into another format. In an aspect, the sampled data may be converted into data having a common format for each of the plurality of software components. For example, the chipset may convert audio data into a graphical representation, such as a spectrograph.

In addition, at 510, the method may include transmitting the sampled data. Wireless device may transmit the sampled data to a server, for example, for storage and/or additional processing, as discussed below in FIGS. 6-7. For example, wireless device may transmit sampled data corresponding to one or more preferences associated with the wireless device, and the sampled data may affect a control of one or more ambient parameters in a location of the wireless device. In an aspect, the chipset may transmit the sampled spectrographs to the server for storage and/or additional processing, such as comparing the spectrographs with a media data repository to identify the song playing on the wireless device. It should also be appreciated that the chipset may detect and transmit the location of the wireless device and/or the time when the raw data is detected along with the sampled data.

At 508, the method may optionally include storing the sampled data so that the sampled data may be transmitted to a server during a later time period. For example, the sampled data may be delayed until an occurrence of a non-peak data communication period and/or until the wireless device is in an idle state.

Referring now to FIG. 6, a method 600 for populating a data repository with individual user preferences in accordance with an aspect includes, at 602, receiving sampled data from one or more wireless devices. For example, a server may receive transmitted sample data from one or more wireless devices as discussed in 510 (FIG. 5) and/or from any other device in communication with the server. A portion of the received sample data may include preference data for the one or more wireless devices.

At 604, the method may optionally include comparing the received sampled data with a library of data to identify the sampled data. For example, the server may compare a received spectrograph of a song playing on a wireless device with a library of music to identify the song playing on the wireless device. Identifying the song playing on a wireless device may be used to infer what type of genre and/or artist that the user of wireless device may prefer. For example, if a user of wireless device listens frequently to songs that are by country music artists, the server may infer that the user of wireless device may prefer listening to country music.

Next, at 606, the method may include populating a data repository of individual user preferences. Populating the data repository of individual user preferences may include, but is not limited to, storing the received sampled data in the data repository, along with any additional information generated from comparing the received sampled data with a library of data, among other information for populating the data repository.

In an aspect, the server may also associate the received sampled data with device identification (ID) and group the received sampled data based upon the device ID. In addition, the server may also receive additional metadata for the sampled data and store the additional metadata with the received sample data. The additional metadata may include, but is not limited to, a location where the sample data was played and/or detected by the wireless device, a time when the received sampled data was played and/or detected by the wireless device, promotions associated with the sampled (e.g., coupons and advertisements), among other metadata. Tracking and storing the metadata along with the received sampled data may illustrate how and/or when the data is captured by the wireless device and may also help determine trends that exists in the captured data. For example, a user of wireless device may listen to one genre of music during the afternoon and a different genre of music a night.

In an aspect, the data repository of individual user preferences may include the type of music the wireless device plays, the location where the wireless device plays the music and the time of day when the wireless device plays the music. By populating a data repository of individual user preferences, the server may be able to create a user history for the one or more wireless devices.

Referring now to FIG. 7, a method 700 for determining preferences in accordance with an aspect includes, at 702, receiving a request for a preference relating to an ambient parameter corresponding to a location. Ambient parameters may include, but are not limited, to music, sound, non-voice audio, video, volume of sound, temperature, lighting, and device sensored parameters, among other ambient parameters that may affect a number of individuals. The server may receive the request from one or more controllable local devices at one or more locations, such as a retail store, an airport, a park, a sports arena, a bookstore, or a restaurant, among other locations where an ambient parameter may be customized.

At 704, the method may include determining a location based preference metric for the requested ambient parameter according to a measure of preference for the ambient parameter corresponding to one or more wireless devices within the location during a time period. In an aspect, a portion of the measure of preferences for each of the one or more wireless devices is based on preference data corresponding to the sampled raw data generated by one of a plurality of software components on each wireless device prior to output of the sampled raw data by an output mechanism on each wireless device.

The server may determine the location based preference metric based upon the preferences of one or more wireless devices currently within the specified location. For example, the server may determine which wireless devices are currently within the location by receiving location information from one or more wireless devices. The server may take a survey in real-time or near real-time of which wireless devices are located within the specified location. In an aspect, the server may determine one or more areas corresponding to a location and adding a device identification of the one or more wireless devices having device location information within the one or more areas to the user population list. Determining one or more areas may include, but is not limited to selecting a center point of the location and calculating a radius from the selected center point. If the location is an open space, such as a park, the server may calculate a center point for the location and determine a radius from the center point to determine which wireless devices are currently within the location. Thus, the area for the specified location may be dynamically calculated and may not be limited to pre-established boundaries surrounding the specified location.

In one aspect, a server may calculate a measure of preference for each of the one or more wireless devices by applying a preference function to at least a portion of the preference data from each of the one or more wireless devices within the location during the time period. For example, the server may aggregate the data of the music currently playing on the one or more wireless devices in the location and calculate the location based preference metric based upon an average music playing on the wireless devices in the location.

In another aspect, a server may access a data repository of individual user preferences (FIG. 6) for the wireless devices within the location and determine based upon the history of the wireless devices in the location, the location based preference metric for the requested parameter. For example, the server may obtain from a user history data store, a historical sampled raw data relating to the requested ambient parameter from a time prior to the current time corresponding to the each of the one or more wireless devices and generate a location based preference metric for the requested ambient parameter by applying a preference function to the obtained historical sampled raw data.

The method may optionally include, at 706, applying factors for weighting the measure of preference for each of the one or more wireless devices, such as a purchase history, purchase power, a user's preference, and a social media status, among other factors. The server may apply factors to weight the location based preference metric in favor of one or more individuals. For example, the server may skew the location based preference metric towards individuals who have a purchase history at the location so that, for example, the preferred music of the individuals who have a purchase history is played even if the preferred music is not an average of the individuals currently within the location. Skewing the location based preference in favor of individuals with a purchase history at the location may encourage those individuals to spend more time in the location, and thus, may increase the amount of money the individuals spend at the location. In addition, the server may skew the location based preference metric based upon the amount of music an individual listens to so that, for example, the preference of individuals who frequently listen to music is played even if the preferred music is not an average of the individuals currently within the location.

Next, at 708, the method may include transmitting the location based preference metric for the requested parameter and/or some other data based on the requested parameter. In an aspect, the server may transmit the location based preference metric to the location that requested the location based preference metric.

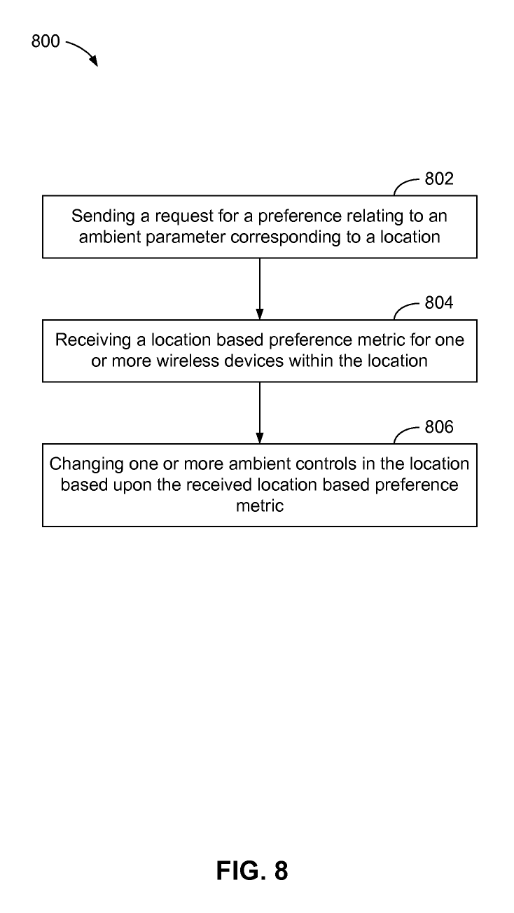

Referring now to FIG. 8, a method 800 for environmental control in accordance with an aspect includes, at 802, requesting a preference relating to an ambient parameter corresponding to a location. Ambient parameters may include, but are not limited, to music, sound, non-voice audio, video, volume of sound, temperature, lighting, and device sensored parameters, among other ambient parameters that may affect a number of individuals. In an aspect, a device at a location may send a request to a server to receive a location based preference for one or more ambient parameters for the location. For example, a retail store may want to tailor one or more requested ambient parameters to the preference of individuals within the retail store to encourage individuals to spend more time shopping in the retail store.

At 804, the method may also include receiving a location based preference metric for one or more wireless devices within the location. The location based preference metric for the requested ambient parameter may be based upon a measure of preference for the ambient parameter corresponding to one or more wireless devices within the location within the location during a time period, as discussed above in FIG. 7. In addition, a portion of the measure of preference for each of the one or more wireless devices may be based upon preference data corresponding to sampled raw data generated by one of a plurality of software components on each wireless device prior to output of the sampled raw data by an output mechanism on each wireless device. For example, the location based preference metric may be an average preference of users of wireless devices within the location during the time period.

Next, at 806, the method may include changing one or more ambient controls in the location based upon the received location based preference metric. Changing one or more ambient controls may include, but is not limited to, changing a genre of music playing in a location, the volume of music playing in a location; a temperature of a location; a lighting of a location, a color displayed in a location, and products on display in a location, among other changes of ambient controls. For example, a retail store may request an average music preference of individuals currently shopping in the retail store and change the genre of music playing in the retail store based upon the received music preference of individuals currently shopping in the store.

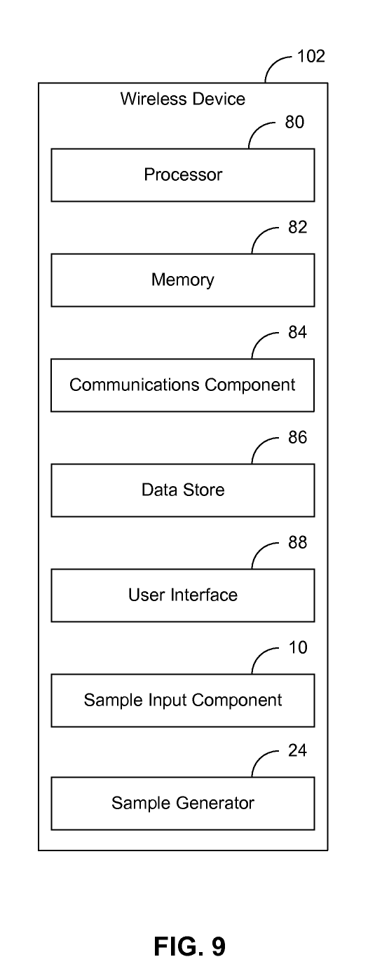

Referring now to FIG. 9, illustrated is an example wireless device 102 operable within the connectivity system in accordance with an aspect. In one aspect, wireless device 102 may include a processor 80 for carrying out processing functions associated with one or more of components and functions described herein. Processor 80 can include a single or multiple set of processors or multi-core processors. Moreover, processor 80 can be implemented as an integrated processing system and/or a distributed processing system.

Wireless device 102 may further include a memory 82, such as for storing local versions of applications being executed by processor 80. Memory 82 can include a type of memory usable by a computer, such as random access memory (RAM), read only memory (ROM), tapes, magnetic discs, optical discs, volatile memory, non-volatile memory, and any combination thereof

Further, wireless device 102 includes a communications component 84 that provides for establishing and maintaining communications with one or more parties utilizing hardware, software, and services as described herein. Communications component 84 may carry communications between components on wireless device 102, as well as between wireless device 102 and external devices, such as devices located across a communications network and/or devices serially or locally connected to wireless device 102. For example, communications component 84 may include one or more buses, and may further include transmit chain components and receive chain components associated with a transmitter and receiver, respectively, operable for interfacing with external devices.

Additionally, wireless device 102 may further include a data store 86, which can be any suitable combination of hardware and/or software, that provides for mass storage of information, databases, and programs employed in connection with aspects described herein. For example, data store 86 may be a data repository for applications not currently being executed by processor 80.

Wireless device 102 may additionally include a user interface component 88 operable to receive inputs from a user of wireless device 102 and further operable to generate outputs for presentation to the user. User interface component 88 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof Further, user interface component 88 may include one or more output devices, including but not limited to a display, a speaker, a haptic feedback mechanism, a printer, any other mechanism capable of presenting an output to a user, or any combination thereof

Wireless device 102 may further include a sample input component 10 operable to generate or otherwise obtain raw data corresponding to operation of the wireless device 102. Wireless device 102 may also include a sample generator component 24 operable for obtaining at least a portion of the obtained raw data as sample data and transmit the sampled data to a server or other computing device for additional processing and/or storing.

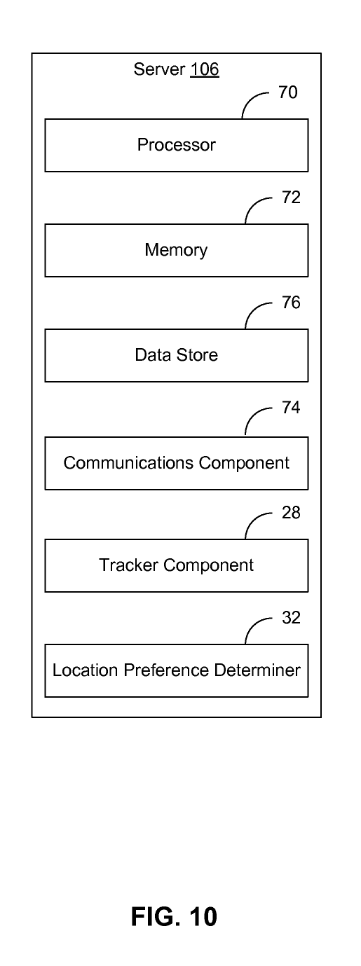

Referring now to FIG. 10, illustrated is an example server device 106 operable within the connectivity system in accordance with yet another aspect. Server 106 manages network connectivity matters for access network 104. Server 106 includes processor component 70 for carrying out processing functions associated with one or more of components and functions described herein. Processor component 70 can include a single or multiple set of processors or multi-core processors. Moreover, processing component 70 can be implemented as an integrated processing system and/or a distributed processing system.

Server 106 further includes a memory 72, such as for storing local versions of applications being executed by processor component 70. Memory 72 can include random access memory (RAM), read only memory (ROM), and a combination thereof

Further, server 106 includes a communications component 34 that provides for establishing and maintaining communications with one or more parties utilizing hardware, software, and services as described herein. Communications component 34 may carry communications between components on server 106, as well as between server 106 and external devices, such as devices located across a communications network and/or devices serially or locally connected to server 106.

Additionally, server 106 may further include a data store 76, which can be any suitable combination of hardware and/or software, that provides for mass storage of information, databases, and programs employed in connection with aspects described herein. For example, data store 76 may be a data repository for applications not currently executing. Server 106 may include a tracker component 29 operable to determine a user population list one or more wireless devices within one or more specified areas corresponding to a location. In addition, server 106 may include a location based preference determiner 32 which may generate a location preference metric for a user population list within the specified location.

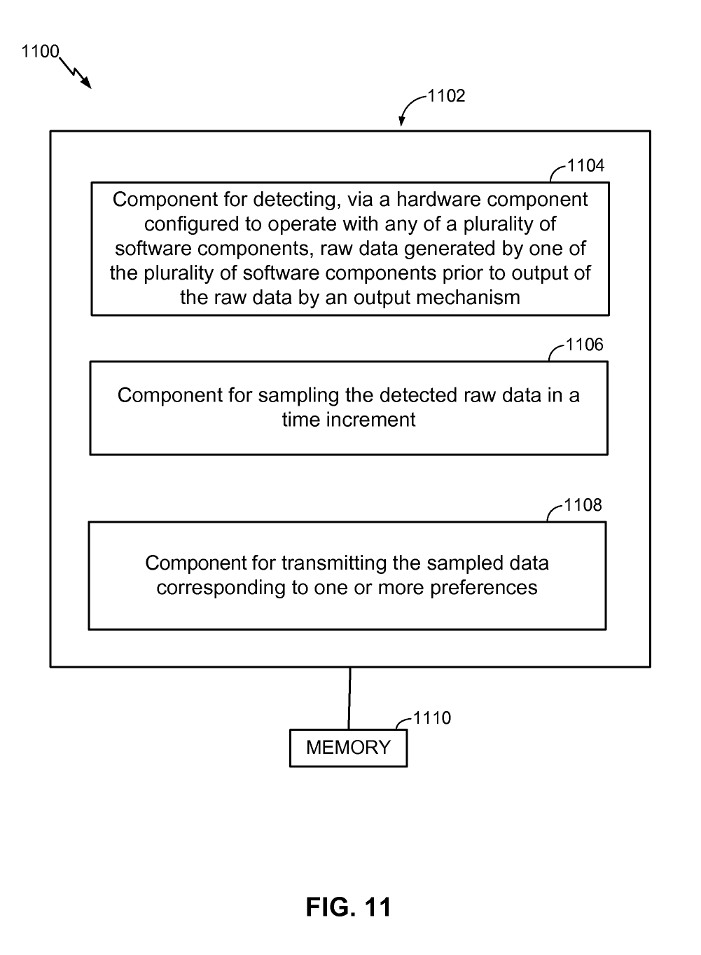

Referring now to FIG. 11, illustrated is a system 1100 configured to provide preference data associated with a wireless device. For example, system 1100 can reside at least partially within a transmitter, mobile device, etc. It is to be appreciated that system 1100 is represented as including functional blocks, which can be functional blocks that represent functions implemented by a processor, software, or combination thereof (e.g., firmware). System 1100 includes a logical grouping 1102 of electrical components that facilitate providing preference data associated with a wireless device. For instance, logical grouping 1102 may include component 1104 for detecting, via a hardware component configured to operate with any of a plurality of software components, raw data generated by one of the plurality of software components prior to output of the raw data by an output mechanism. Further, logical grouping 1102 may comprise component 1106 for sampling the detected raw data in a time increment. In addition, logical grouping 1102 may include component 1108 for transmitting the sampled data corresponding to one or more preferences, wherein the sampled data affects a control of one or more ambient parameters in a location of the wireless device. Additionally, system 1100 can include a memory 1110 that retains instructions for executing functions associated with electrical components 1104, 1106, and 1108. While shown as being external to memory 1110, it is to be understood that one or more of electrical components 1104, 1106, and 1108 can exist within memory 1110.

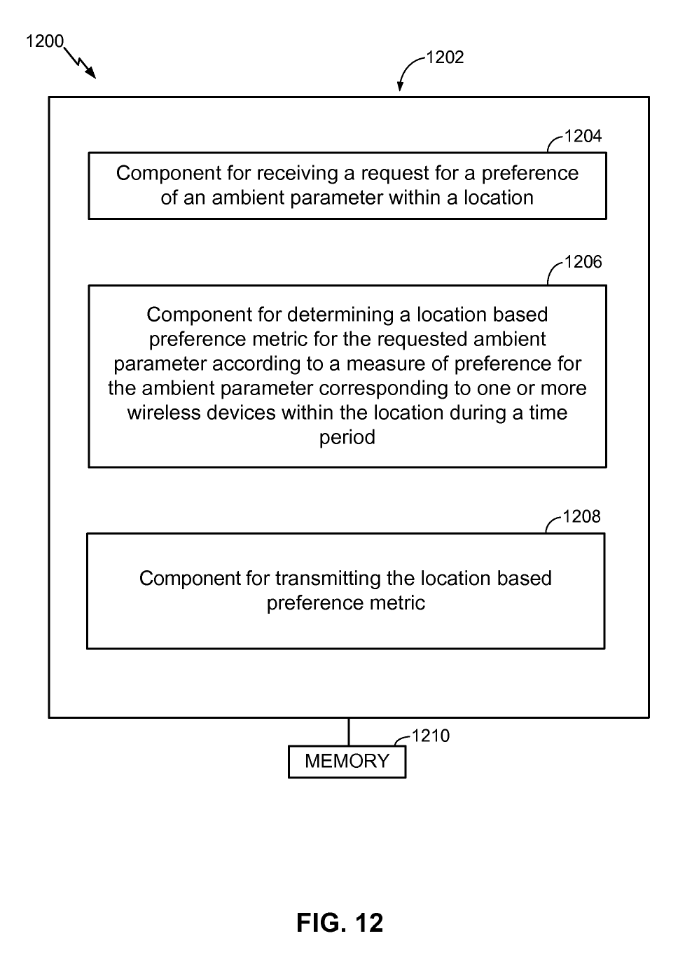

Referring now to FIG. 12, illustrated is a system 1200 configured to facilitate determining preferences. For example, system 1200 can reside at least partially within a transmitter, mobile device, etc. It is to be appreciated that system 1200 is represented as including functional blocks, which can be functional blocks that represent functions implemented by a processor, software, or combination thereof (e.g., firmware). System 1200 includes a logical grouping 1202 of electrical components that facilitate determining preferences. For instance, logical grouping 1202 may include component 1204 for receiving a request for a preference relating to an ambient parameter corresponding to a location. Further, logical grouping 1202 may comprise component 1206 for determining a location based preference metric for the requested ambient parameter according to a measure of preference for the ambient parameter corresponding to one or more wireless devices within the location during a time period. In addition, logical grouping 1202 may include component 1208 for transmitting the location based preference metric. Additionally, system 1200 can include a memory 1210 that retains instructions for executing functions associated with electrical components 1204, 1206, and 1208. While shown as being external to memory 1210, it is to be understood that one or more of electrical components 1204, 1206, and 1208 can exist within memory 1210.

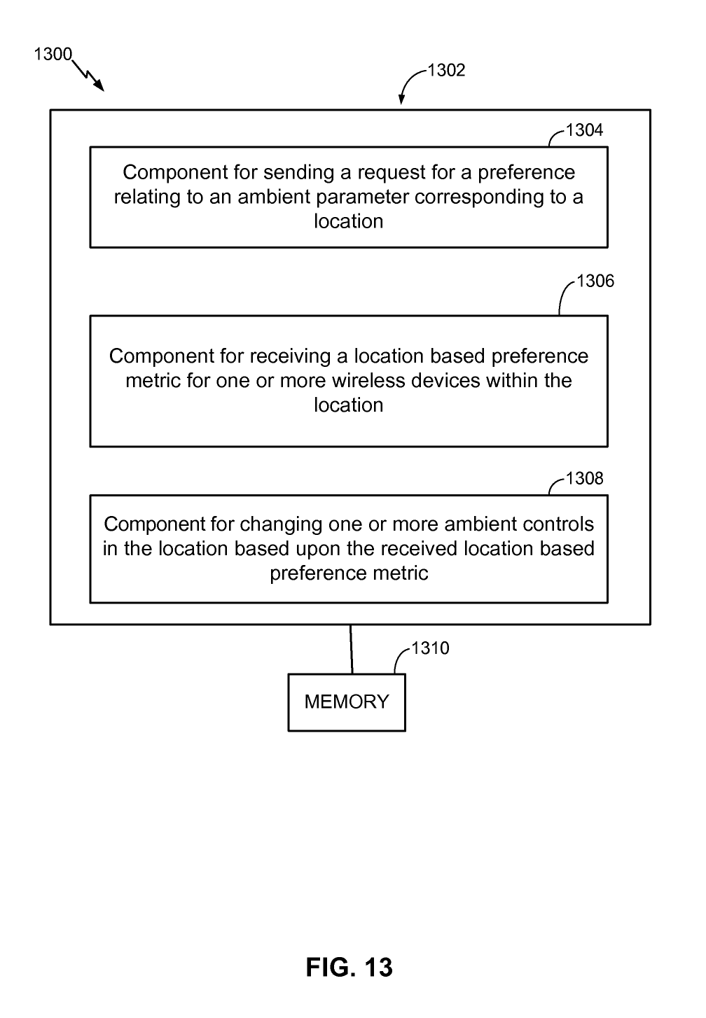

Referring now to FIG. 13, illustrated is a system 1300 configured to facilitate environmental control. For example, system 1300 can reside at least partially within a transmitter, mobile device, etc. It is to be appreciated that system 1300 is represented as including functional blocks, which can be functional blocks that represent functions implemented by a processor, software, or combination thereof (e.g., firmware). System 1300 includes a logical grouping 1302 of electrical components that facilitate environmental control. For instance, logical grouping 1302 may include component 1304 for sending a request for a preference relating to an ambient parameter corresponding to a location. Further, logical grouping 1302 may comprise component 1306 for receiving a location based preference metric for one or more wireless devices within the location. In addition, logical grouping 1302 may include component 1308 for changing one or more ambient controls in the location based upon the received location based preference metric. Additionally, system 1300 can include a memory 1310 that retains instructions for executing functions associated with electrical components 1304, 1306, and 1308. While shown as being external to memory 1310, it is to be understood that one or more of electrical components 1304, 1306, and 1308 can exist within memory 1310.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95, and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM , etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE, and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long- range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs usually reproduce data optically with lasers. Combinations of the above should also be included within the scope of computer-readable media.

While the foregoing disclosure discusses illustrative aspects and/or implementations, it should be noted that various changes and modifications could be made herein without departing from the scope of the described aspects and/or implementations as defined by the appended claims. Furthermore, although elements of the described aspects and/or implementations may be described or claimed in the singular, the plural is contemplated unless limitation to the singular is explicitly stated. Additionally, all or a portion of any aspect and/or implementation may be utilized with all or a portion of any other aspect and/or implementation, unless stated otherwise.

What is claimed is:

1. A method for providing preference data associated with a wireless device, the method comprising:
detecting, via a hardware component configured to operate with any of a plurality of software components, raw data generated by one of the plurality of software components prior to output of the raw data by an output mechanism, wherein the raw data corresponds to one or more preferences;
sampling the detected raw data in a time increment; and
transmitting the sampled data corresponding to one or more preferences, wherein the sampled data affects a control of one or more ambient parameters in a location of the wireless device.

2. The method of claim 1, further comprising:
converting the sampled raw data into converted data having a common format for each of the plurality of software components,
wherein transmitting the preference data further comprises transmitting the converted data.

3. The method of claim 2, wherein the raw data comprises non-voice call audio data, and wherein the converted data comprises a spectrograph.

4. The method of claim 1, wherein the detecting via the hardware component further comprises detecting via a chipset on the wireless device.

5. The method of claim 1, further comprising:
storing the sampled raw data; and
delaying the transmitting of the preference data for a period of time.

6. The method of claim 5, wherein delaying the transmission for the period of time further comprises delaying until an occurrence of a non-peak data communication period or until the wireless device is in an idle state.

7. The method of claim 1, further comprising:
determining a location of the wireless device when the raw data is sampled;
associating the location with the sampled raw data,
wherein transmitting the preference data further comprises transmitting the corresponding location.

8. The method of claim 7, further comprising:
capturing a time when the raw data is sampled,
wherein transmitting the preference data further comprises transmitting the corresponding time.

9. The method of claim 1, wherein the plurality of software components comprises one or more of different software applications or different operating systems.

10. The method of claim 1, further comprising sampling one or more of a device state parameters or a device external environment parameter.

11. The method of claim 10, wherein the device external environment parameter comprises a parameter sensed adjacent to the wireless device.

12. The method of claim 11, wherein the device external environment parameter comprises one of temperature, lighting level, music, or audio volume.

13. The method of claim 10, wherein the device state parameter comprises one or more device settings.

14. At least one processor configured to provide preference data associated with a wireless device, the processor comprising:
a first module for detecting, via a hardware component configured to operate with any of a plurality of software components, raw data generated by one of the plurality of software components prior to output of the raw data by an output mechanism, wherein the raw data corresponds to one or more preferences;
a second module for sampling the detected raw data in a time increment; and
a third module for transmitting the sampled data corresponding to one or more preferences, wherein the sampled data affects a control of one or more ambient parameters in a location of the wireless device.

15. A computer program product for providing preference data associated with a wireless device, comprising:
a computer-readable medium comprising:
at least one instruction for causing a computer to detect, via a hardware component configured to operate with any of a plurality of software components, raw data generated by one of the plurality of software components prior to output of the raw data by an output mechanism, wherein the raw data corresponds to one or more preferences;
at least one instruction for causing the computer to sample the detected raw data in a time increment; and
at least one instruction for causing the computer to transmit the sampled data corresponding to one or more preferences, wherein the sampled data affects a control of one or more ambient parameters in a location of the wireless device.

16. An apparatus for providing preference data associated with a wireless device, comprising:
means for detecting, via a hardware component configured to operate with any of a plurality of software components, raw data generated by one of the plurality of software components prior to output of the raw data by an output mechanism, wherein the raw data corresponds to one or more preferences;
means for sampling the detected raw data in a time increment; and
means for transmitting the sampled data corresponding to one or more preferences, wherein the sampled data affects a control of one or more ambient parameters in a location of the wireless device.

17. A wireless device for communicating data, comprising:
a detector operable to detect raw data generated by one of a plurality of software components prior to output of the raw data by an output mechanism, wherein the raw data corresponds to one or more preferences;
a sampler operable to sample the detected raw data in a time increment; and
a transmitter operable to transmit the sampled data corresponding to one or more preferences, wherein the sampled data affects a control of one or more ambient parameters in a location of the wireless device.

18. The wireless device of claim 17, further comprising:
a converter operable to convert the sampled raw data into converted data having a common format for each of the plurality of software components,
wherein the transmitter is further operable to transmit the converted data.

19. The wireless device of claim 18, wherein the raw data comprises non-voice call audio data, and wherein the converted data comprises a spectrograph.

20. The wireless device of claim 17, wherein the detector is further operable to detect via a chipset on the wireless device.

21. The wireless device of claim 17, further comprising:
a sample generator operable to store the sampled raw data and delay the transmission of the preference data for a period of time.

22. The wireless device of claim 21, wherein the delay of the transmission for the period of time further comprises delaying until an occurrence of a non-peak data communication period or until the wireless device is in an idle state.

23. The wireless device of claim 17, further comprising:
a location component operable to determine a location of the wireless device when the raw data is sampled and associate the location with the sampled data,
wherein the transmitter is further operable to transmit the preference data and the corresponding location.

24. The wireless device of claim 23, further comprising:
a clock component operable to capture a time when the raw data is sampled,
wherein the transmitter component is further operable to transmit the preference data and the corresponding time.

25. The wireless device of claim 17, wherein the plurality of software components comprise one or more of different software applications or different operating systems.

26. The wireless device of claim 17, further comprising a sampler component operable to sample one or more of a device state parameter or a device external environment parameter.

27. The wireless device of claim 25, wherein the device external environment parameter comprises a parameter sensed adjacent to the wireless device.

28. The wireless device of claim 27, wherein the device external environment parameter comprises one of temperature, lighting level, music, or audio volume.

29. The wireless device of claim 25, wherein the device state parameter comprises one or more device settings.

30. A method for determining preferences, the method comprising:
receiving a request for a preference relating to an ambient parameter corresponding to a location;
determining a location based preference metric for the requested ambient parameter according to a measure of preference for the ambient parameter corresponding to one or more wireless devices within the location during a time period, wherein at least a portion of the measure of preference for each of the one or more wireless devices is based on preference data corresponding to sampled raw data generated by one of a plurality of software components on each wireless device prior to output of the sampled raw data by an output mechanism on each wireless device; and
transmitting the location based preference metric.

31. The method of claim 30, further comprising determining the measure of the preference for each of the one or more wireless devices by applying a preference function to at least a portion of the preference data from each of the one or more wireless devices within the location during the time period, wherein the time period comprises a current time.

32. The method of claim 31, wherein determining the location based preference metric further comprises:
obtaining, from a user history data store, historical sampled raw data relating to the requested ambient parameter from a time prior to the current time corresponding to each of the one or more wireless devices; and
generating the location based preference metric for the requested ambient parameter by applying a preference function to the obtained historical sampled raw data.

33. The method of claim 30, further comprising:
determining a user population list of the one or more wireless devices within the location during the time period; and
calculating the measure of the preference for the parameter based upon the user population list.

34. The method of claim 33, wherein determining the user population list further comprises:
determining one or more areas corresponding to the location; and
adding a device identification of the one or more wireless devices having device location information within the one or more areas to the user population list.

35. The method of claim 33, wherein determining one or more areas further comprises:
selecting a center point of the location; and
calculating a radius from the selected center point.

36. The method of claim 30, further comprising weighting the measure of the preference for each of the one or more wireless devices based upon a purchase history of a user corresponding to each of the one or more wireless devices.

37. The method of claim 30, further comprising:
receiving the sampled raw data from one or more wireless devices;
comparing the received sampled raw data with a plurality of sets of data, wherein each of the plurality of sets of data corresponds to a different ambient parameter; and
matching the received raw data to one of the plurality of sets of data to identify the ambient parameter corresponding to the received raw data.

38. The method of claim 37, wherein the plurality of sets of data each correspond to different ones of a plurality of songs.

39. The method of claim 30, further comprising:
determining sets of sampled raw data for each of the one or more devices corresponding to the requested ambient parameter,
wherein determining the location based preference metric further comprises determining using the determined sets of sampled raw data corresponding to the requested ambient parameter.

40. At least one processor configured to determine preferences, the processor comprising:
a first module for receiving a request for a preference relating to an ambient parameter corresponding to a location;
a second module for determining a location based preference metric for the requested ambient parameter according to a measure of preference for the ambient parameter corresponding to one or more wireless devices within the location during a time period, wherein at least a portion of the measure of preference for each of the one or more wireless devices is based on preference data corresponding to sampled raw data generated by one of a plurality of software components on each wireless device prior to output of the sampled raw data by an output mechanism on each wireless device; and
a third module for transmitting the location based preference metric.

41. A computer program product, comprising:
a computer-readable medium comprising:
at least one instruction for causing a computer to receive a request for a preference relating to an ambient parameter corresponding to a location;
at least one instruction for causing the computer to determine a location based preference metric for the requested ambient parameter according to a measure of preference for the ambient parameter corresponding to one or more wireless devices within the location during a time period, wherein at least a portion of the measure of preference for each of the one or more wireless devices is based on preference data corresponding to sampled raw data generated by one of a plurality of software components on each wireless device prior to output of the sampled raw data by an output mechanism on each wireless device; and
at least one instruction for causing the computer to transmit the location based preference metric.

42. An apparatus comprising:
means for receiving a request for a preference relating to an ambient parameter corresponding to a location;
means for determining a location based preference metric for the requested ambient parameter according to a measure of preference for the ambient parameter corresponding to one or more wireless devices within the location during a time period, wherein at least a portion of the measure of preference for each of the one or more wireless devices is based on preference data corresponding to sampled raw data generated by one of a plurality of software components on each wireless device prior to output of the sampled raw data by an output mechanism on each wireless device; and
means for transmitting the location based preference metric.

43. A server for transmitting a location based preference metric for a requested parameter and location, the server comprising:
a location based preference determiner operable to:
receive a request for a preference relating to an ambient parameter corresponding to a location,
determine a location based preference metric for the requested ambient parameter according to a measure of preference for the ambient parameter corresponding to one or more wireless devices within the location during a time period, wherein at least a portion of the measure of preference for each of the one or more wireless devices is based on preference data corresponding to sampled raw data generated by one of a plurality of software components on each wireless device prior to output of the sampled raw data by an output mechanism on each wireless device, and
transmit the location based preference metric.

44. The server of claim 43, wherein the location based preference determiner is further operable to determine the measure of the preference for each of the one or more wireless devices by applying a preference function to at least a portion of the preference data from each of the one or more wireless devices within the location during the time period, wherein the time period comprises a current time.

45. The server of claim 44, wherein the location based preference determiner is further operable to obtain, from a user history data store, historical sampled raw data relating to the requested ambient parameter from a time prior to the current time corresponding to each of the one or more wireless devices; and generate the location based preference metric for the requested ambient parameter by applying a preference function to the obtained historical sampled raw data.

46. The server of claim 43, further comprising:
a tracker component operable to determine a user population list of the one or more wireless devices within the location during the time period; and
a calculator component operable to calculate the measure of the preference for the parameter based upon the user population list.

47. The server of claim 46, wherein the tracker component is further operable to determine the user population list by determining one or more areas corresponding to the location and adding a device identification of the one or more wireless devices having device location information within the one or more areas to the user population list.

48. The server of claim 46, wherein the tracker component is further operable to determine one or more areas by selecting a center point of the location and calculating a radius from the selected center point.

49. The server of claim 43, further comprising weighting the measure of the preference for each of the one or more wireless devices based upon a purchase history of a user corresponding to each of the one or more wireless devices.

50. The server of claim 43, wherein the location based preference determiner operable to receive the sampled raw data from one or more wireless devices, compare the received sampled raw data with a plurality of sets of data, wherein each of the plurality of sets of data corresponds to a different ambient parameter, and match the received raw data to one of the plurality of sets of data to identify the ambient parameter corresponding to the received raw data.

51. The server of claim 50, wherein the plurality of sets of data each corresponds to different ones of a plurality of songs.

52. The server of claim 43, wherein the location based preference determiner is further operable to determine sets of sampled raw data for each of the one or more devices corresponding to the requested ambient parameter, and wherein determining the location based preference metric further comprises determining using the determined sets of sampled raw data corresponding to the requested ambient parameter.

53. A method of environmental control, comprising:
sending a request for a preference relating to an ambient parameter corresponding to a location;
receiving a location based preference metric for one or more wireless devices within the location, wherein the location based preference metric for the requested ambient parameter is based on a measure of preference for the ambient parameter corresponding to one or more wireless devices within the location during a time period, wherein at least a portion of the measure of preference for each of the one or more wireless devices is based on preference data corresponding to sampled raw data generated by one of a plurality of software components on each wireless device prior to output of the sampled raw data by an output mechanism on each wireless device; and
changing one or more ambient controls in the location based upon the received location based preference metric.

54. The method of claim 53, wherein the location corresponds to a controller that directs the one or more ambient controls.

55. The method of claim 53, wherein changing one or more ambient controls comprises changing one of a genre of music playing in the location, a volume of the music playing in the location, a temperature of the location, a lighting in the location, a color in the location, or product displays in the location.

56. At least one processor configured for environmental control, the processor comprising:
a first module for sending a request for a preference relating to an ambient parameter corresponding to a location;
a second module for receiving a location based preference metric for one or more wireless devices within the location, wherein the location based preference metric for the requested ambient parameter is based on a measure of preference for the ambient parameter corresponding to one or more wireless devices within the location during a time period, wherein at least a portion of the measure of preference for each of the one or more wireless devices is based on preference data corresponding to sampled raw data generated by one of a plurality of software components on each wireless device prior to output of the sampled raw data by an output mechanism on each wireless device; and
a third module for changing one or more ambient controls in the location based upon the received location based preference metric.

57. A computer program product, comprising:
a computer-readable medium comprising:
at least one instruction for causing a computer to send a request for a preference relating to an ambient parameter corresponding to a location;
at least one instruction for causing the computer to receive a location based preference metric for one or more wireless devices within the location, wherein the location based preference metric for the requested ambient parameter is based on a measure of preference for the ambient parameter corresponding to one or more wireless devices within the location during a time period, wherein at least a portion of the measure of preference for each of the one or more wireless devices is based on preference data corresponding to sampled raw data generated by one of a plurality of software components on each wireless device prior to output of the sampled raw data by an output mechanism on each wireless device; and
at least one instruction for causing the computer to change one or more ambient controls in the location based upon the received location based preference metric.

58. An apparatus comprising:
means for sending a request for a preference relating to an ambient parameter corresponding to a location;
means for receiving a location based preference metric for one or more wireless devices within the location, wherein the location based preference metric for the requested ambient parameter is based on a measure of preference for the ambient parameter corresponding to one or more wireless devices within the location during a time period, wherein at least a portion of the measure of preference for each of the one or more wireless devices is based on preference data corresponding to sampled raw data generated by one of a plurality of software components on each wireless device prior to output of the sampled raw data by an output mechanism on each wireless device; and
means for changing one or more ambient controls in the location based upon the received location based preference metric.

59. An apparatus for environmental control, comprising:
a requestor component operable to send a request for a preference relating to an ambient parameter corresponding to a location;
a controller operable to receive a location based preference metric for one or more wireless devices within the location, wherein the location based preference metric for the requested ambient parameter is based on a measure of preference for the ambient parameter corresponding to one or more wireless devices within the location during a time period, wherein at least a portion of the measure of preference for each of the one or more wireless devices is based on preference data corresponding to sampled raw data generated by one of a plurality of software components on each wireless device prior to output of the sampled raw data by an output mechanism on each wireless device; and
an ambient control component operable to change one or more ambient controls in the location based upon the received location based preference metric.

60. The apparatus of claim 59, wherein the location corresponds to a controller that directs the one or more ambient controls.

61. The apparatus of claim 59, wherein the ambient control component is further operable to change one of a genre of music playing in the location, a volume of the music playing in the location, a temperature of the location, a lighting in the location, a color in the location, or product displays in the location.
